(19) United States
(12) Patent Application Publication
(10) Pub. No.: US 2010/0057612 A1
(43) Pub. Date: Mar. 4, 2010

(54) KIOSK BASED PURCHASING SYSTEM

(75) Inventor: Fred Wagenhals, (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: FAN HUB LLC, Scottsdale, AZ (US)

(21) Appl. No.: 12/203,754

(22) Filed: Sep. 3, 2008

(51) Int. Cl. G06Q 30/00; G06Q 40/00; G06Q 90/00; G06F 17/30

(52) U.S. Cl. 705/40; 705/27; 705/26; 705/14.37

(57) ABSTRACT

A kiosk based purchasing system coupled by a network to a payment processor and fulfillment house. The system includes a plurality of kiosks coupled to one or more servers. Each of the kiosks has an embedded computing system configured to display information related to product offerings stored in its system memory to a customer without accessing the network. Customers input orders and related payment information into the kiosks. Each order identifies at least one product and includes a shipping address. Each kiosk transmits each order and related payment information to the servers. The servers transmit the payment information to the payment processor, which either approves or rejects the payment. If the payment is approved, the server transmits the order to the fulfillment house, which ships the products identified in the order to the shipping address. Kiosks may be transported to events, and configured to sell products related to those events.

### BACKGROUND OF THE INVENTION

1. Field of the Invention

The present invention is directed generally to systems and methods of purchasing goods and more particularly to systems including kiosks used to purchase goods at a first location that are shipped from a second location to a third location.

2. Description of the Related Art

Purchasing, tracking, and maintaining inventory induces both start up business costs as well as ongoing overhead costs. Many Internet based businesses avoid these costs by acting as intermediaries between purchasers of goods and suppliers of those goods. For example, a website may offer books for sale but any books purchased on the website are actually shipped directly from an inventory of those books owned by a third party. While this model has worked well for many businesses, it has several drawbacks.

First, a multipurpose computing device such as a personal computer executing an Internet Brower is typically required to access such Internet based businesses. Second, to purchase goods from the website, a purchaser must know about the website, know its web address, and be able to access it. Finally, many users will take advantage of search engines to comparison shop many websites. Therefore, customers may locate another Internet based business offering the same product for a lower price, or having a better or more attractive interface, resulting in lost sales. Further, customers may unknowingly purchase gray market or counterfeit goods. Therefore, a need exists for a system that automatically routes customers to a desired Internet based business without the risk that the customers will purchase goods from another vendor.

At some events, such as NASCAR races, and other sporting events, some vendors operate booths or other stands selling goods related to the event. Similarly, vendors sell related goods at many other types of attractions. For example, vendors at county fairs, museums, historical sights, and the like typically sell goods related to those attractions. Unfortunately, selling goods at events and other attractions typically involves transporting a finite amount of inventory to the site. During transport, such goods may become damaged. Further, a vendor may sell out of a popular item causing an undesirable loss in sales. This prior art method is also undesirable for customers who are forced to carry their purchases around. Customers who are traveling must pack their purchases in luggage potentially damaging them. Therefore, a need exists for a method of selling goods to customers that avoids the problems related to transporting goods to event and attraction sites. The present application provides these and other advantages as will be apparent from the following detailed description and accompanying figures.

### BRIEF DESCRIPTION OF THE SEVERAL VIEWS OF THE DRAWING(S)

FIG. 1 is diagram of a kiosk based purchasing system.

FIG. 2 is a schematic diagram of a computer environment suitable for implementing components of the kiosk based purchasing system of FIG. 1.

FIG. 3 is a block diagram of an exemplary embodiment of a kiosk of the kiosk based purchasing system of FIG. 1.

FIG. 4 is a flow diagram of a method performed by the kiosk of FIG. 3.

FIG. 5 is a flow diagram of a method performed by the kiosk of FIG. 3.

FIG. 6 is a block diagram of a system memory of a server of the kiosk based purchasing system of FIG. 1.

FIG. 7 is a flow diagram of a method performed by the server of FIG. 6.

### DETAILED DESCRIPTION OF THE INVENTION

### System Overview

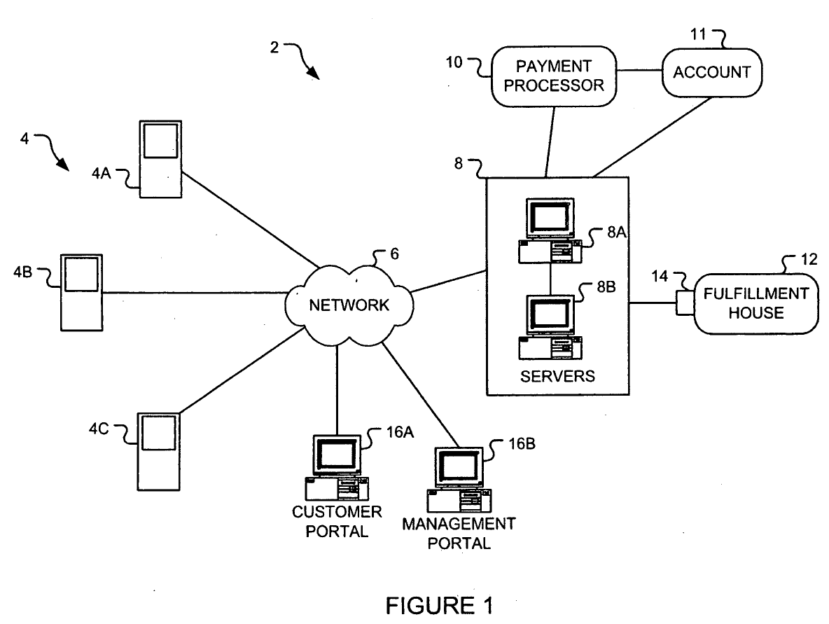

Referring to FIG. 1, aspects of the present invention include a kiosk based purchasing system 2 for ordering products. The system 2 includes one or more kiosks 4 (e.g., 4A, 4B, and 4C) coupled to a network 6, such as a cellular network, the Internet, a LAN, WAN, combinations thereof, and the like. The system 2 also includes one or more one or more servers 8 (e.g., servers 8A and 8B) each coupled to the network 6 and in communication with the kiosks 4.

The kiosks 4 advertise products for sale, and allow customers to select and purchase the products advertised. These orders are transmitted by the kiosks 4 over the network 6 to the servers 8 to be filled. The products ordered are shipped to addresses provided by the customers. Thus, the kiosks 4 eliminate the need for onsite inventory at the location of the kiosks 4. Further, because the kiosks 4 do not dispense products, the customer need not transport or separately ship the products ordered.

The kiosks 4 may be constructed to be portable. For example, the kiosks 4 may be transported to a location of an event, such as a sporting event, configured for use by customers and removed from the location of the event after the event is over. Then, transported to a location of a different event. The products offered for sale by the kiosks 4 may be targeted to customers likely to be at the locations of the kiosks 4. For example, if the kiosk 4A is located at an automotive parts store, the products offered for sale by the kiosk 4A may include products related to automobiles. Similarly, if the kiosk 4B is located at a sporting event, the products offered for sale by the kiosk 4B may include products related to that event, such as hats, pennants, shirts, and the like bearing the names of the participants in the event.

The kiosks 4 receive information related to their product offerings from the servers 8. The servers 8 may include information related to a plurality of product groupings. In such embodiments, the kiosks 4 may offer products for sale in one or more product groupings. Each product grouping may be characterized as a store. Within a product grouping or store, products may be categorized. These categories may be used to display the products to the user and to help the user browse the products by category.

Each of the kiosks 4 may offer products for sale in one or more store. For example, the servers 8 may include a first product grouping including products related to automobiles. This product grouping may be characterized as an automotive store. Similarly, the servers 8 may include a second product grouping including products related to a particular sporting event (e.g., NBA game, NASCAR race, Ryder Cup, and the like). This product grouping may be characterized as an event store. By way of non-limiting examples, the stores (or product groupings) provided by the servers 8 to the kiosks 4 may include a music store having products related to music, a golf store having products related to golf, a store offering products that mirror those offered by a brick and mortar store, a ticket store that sells event tickets, and the like. The ticket store could offer on-site ticket sales and merchandise shipped by the fulfillment house 12 to a shipping address. The merchandise may be related to the events for which tickets are sold, e.g., compact disks, T-shirts, etc. Further, the ticket store could sell such merchandise bundled together with one or more event tickets. Kiosks configured to provide a ticket store could be placed in retail stores and other retail environments.

The servers 8 push product offerings to the kiosks 4 in a process that is offline and separate from customer interaction with the kiosks. For example, the servers 8 may push product offerings to the kiosks 4 when they are first powered up, at predetermined times, as updated product information becomes available, and so forth. When customers view advertising information and browse product offerings, customers are viewing content stored on the kiosk and not the servers 8. Thus, when a customer is browsing product offerings and entering product selections, the kiosks 4 do not contact the servers 8 over the network 6 for content to display to the customer.

Each of the kiosks 4 is configured to display advertising information related to its product offerings, and to allow customers to browse those product offerings to select products for purchase. Each of the kiosks 4 is further configured to receive product selection and order information from a customer. The product selections may accumulate in a shopping cart type interface commonly used in web interfaces. After the customer his indicated he/she is finished shopping, the kiosks 4 prompt the customer for payment and shipping information. The kiosks 4 may also prompt the customer to enter an email address to which purchase related information may be sent. Then, the kiosks 4 transmit that information over the network 6 to at least one of the servers 8 (e.g., 8A and 8B). The order information includes at least one product identifier, quantity information, a delivery address, and payment information.

A payment processor 10, such as a credit card processor, is coupled to the network 6. At least one of the servers 8 communicates the payment information received from the kiosks 4 to the payment processor 10 over the network 6. Methods of processing electronic funds transfers are well known in the art and will not be described in detail. As is apparent to those of ordinary skill, after the payment processor 10 debits funds from a customer account associated with a customer, the payment processor transfers those funds to an account associated with an operator of the system 2. Many payment transfer methods are known in the art and the present disclosure is not limited to any particular method. FIG. 1 illustrates an account 11 (e.g., bank account, credit card account, and the like) into which the payment processor 10 deposits funds debited from a customer account. Further, as appropriate, the payment processor 10 may refund funds deposited in the account 11 to a customer account.

A fulfillment house 12 is also coupled to the network 6 by a computing device 14. At least one of the servers 8 communicates the product identifier, quantity information, and delivery address received from the kiosks 4 to the fulfillment house 12. In response to receiving this information, the fulfillment house 12 fills the orders placed by the customers at the kiosks 4 by shipping the products identified in the quantities specified to the delivery addresses provided.

If both the payment processor 10 and the fulfillment house 12 approve and/or confirm the order, the servers 8 notify the kiosks 4, which optionally print a receipt for the customer, send an email to the customer, and the like. Alternatively, the servers 8 may send the email to the customer. The servers 8 may also send notifications to the customer if a problem filling the order occurs.

One or more client computing devices 16A and 16B are also coupled to the network 6 and configured to communicate with the servers 8. The client computing device 16A is configured as a customer portal 17A to the servers 8. The customer portal 17A allows the customer to view information related to orders placed by the customer on one or more of the kiosks 4. For example, the customer portal 17A may display an expected or actual shipment date of the orders placed by the customer on the kiosks 4. The customer portal 17A may allow the customer to cancel orders placed on the kiosks 4, change the quantity of products ordered, modify the order to include different products, and the like. The customer portal 17A may be generated by the servers 8 and presented by the client computing device 16A to the customer using a web browser, such as Internet Explorer, Firefox, and the like.

The client computing device 16B is configured as a management portal 17B to the servers 8. The management portal 17B is used by the operator of the system 2 to monitor remotely one or more kiosks 4, monitor the account 11, transfer funds to the fulfillment house 12, monitor fulfillment house 12 activities (e.g., shipping, order processing, etc.), identify products offered by the fulfillment house, and receive information related to products offered by the fulfillment house. The management portal 17B may be generated by the servers 8 and presented by the client computing device 16B to the customer using a web browser, such as Internet Explorer, Firefox, and the like.

Each of the components of the system 2 may be located remotely to one another. For example, the kiosks 4A, 4B, and 4C may remote to one another. The client computing devices 16A and 16B may be remote to one another, the kiosks 4, the servers 8, the payment processor 10, and the fulfillment house 12. The servers 8 may be remote to the kiosks 4, the payment processor 10, and the fulfillment house 12. Likewise, the kiosks 4 may be remote to the payment processor 10, and the fulfillment house 12

In particular embodiments, one or more of the kiosks 4 of the system 2 may be sold or leased to third parties (referred to herein as users). For each user, permission to access selected components of the system 2 may be granted. For example, each user may be provided with a login and password with which to access the servers 8 over the network 6 for the purpose of registering a kiosk for use. In such embodiments, a separate account (not shown) may be created for each user, the account 11 may include separate sub-accounts (not shown) for each user, or standard accounting methods may be used to track each user's portion of the funds in the account 11. Funds may be transferred from the account 11 to an account associated with a user. By way of a non-limiting example, funds may be transferred to a user's account periodically (e.g., weekly).

The operator of the system 2 may limit which stores the kiosks 4 purchased or leased by a user may present to customers. The servers 8 may collect statistics related to purchases made at each of the kiosks 4 and display the statistics to users using the management portal 17B.

Each of these users may use the management portal 17B to monitor remotely one or more kiosks 4 purchased or leased by the user, monitor the user's portion of the account 11, transfer funds to the fulfillment house 12, monitor fulfillment house 12 activities (e.g., shipping, order processing, etc.), identify products offered by the fulfillment house, and receive information related to products offered by the fulfillment house.

### Computing Devices

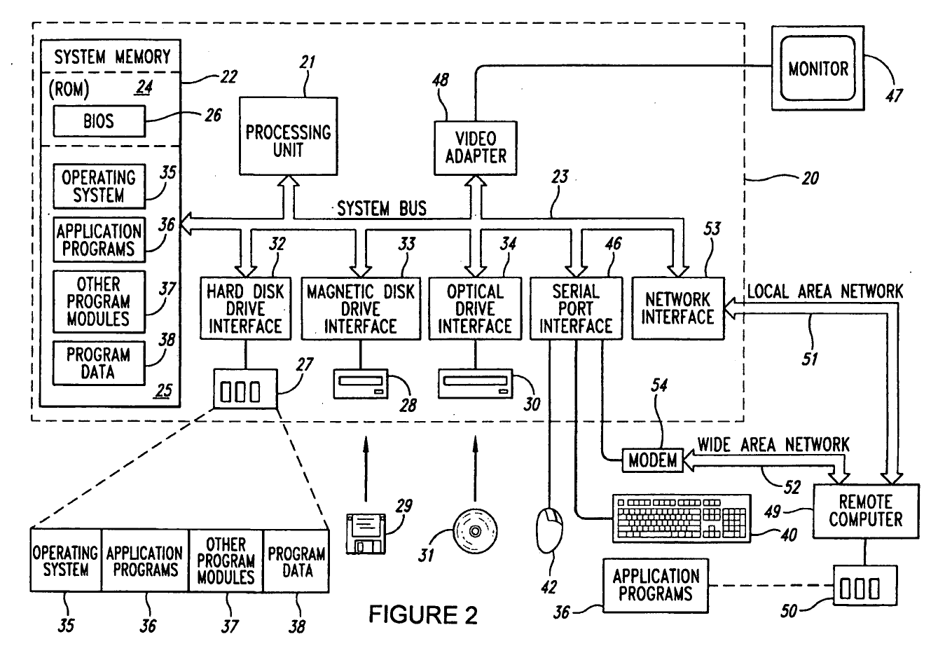

The exemplary hardware and operating environment of FIG. 2 includes a general-purpose computing device in the form of a computer 20. Each of the one or more servers 8, the payment processor 10, the computing device 14, and the client computing devices 16A and 16B may be implemented using the computer 20. Further, as will be described below, many of the components of the computer 20 may be used to construct the kiosks 4.

The computer 20 includes a processing unit 21, a system memory 22, and a system bus 23 that operatively couples various system components, including the system memory 22, to the processing unit 21. There may be only one or there, may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20 (as the local computer). Implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 2. The logical connections depicted in FIG. 2 include a local-area network (LAN) 51 and a wide-area network (WAN) 52. Such networking environments are commonplace in offices, enterprise-wide computer networks, intranets and the Internet. As mentioned above, the network 13 may include any of these networking environments.

When used in a LAN-networking environment, the computer 20 is connected to the local area network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device 50. It is appreciated that the network connections shown are exemplary and other means of and communications devices for establishing a communications link between the computers may be used.

The computing device 20 and related components have been presented herein by way of particular example and also by abstraction in order to facilitate a high-level view of the concepts disclosed. The actual technical design and implementation may vary based on particular implementation while maintaining the overall nature of the concepts disclosed.

### Kiosks

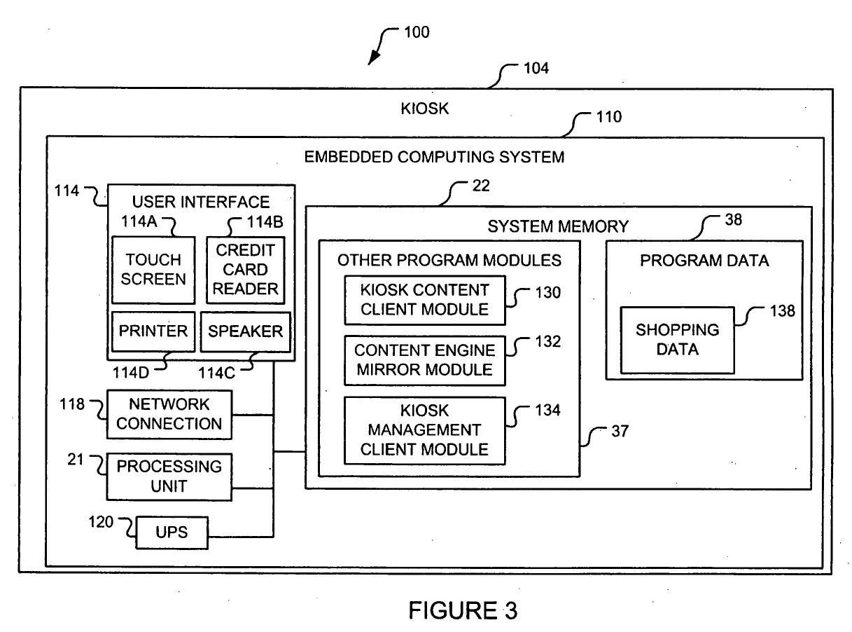

FIG. 3 provides an illustration of an exemplary kiosk 100. Each of the kiosks 4 illustrated in FIG. 1 may be constructed in accordance with the kiosk 100. The kiosk 100 includes a housing 104 and an embedded computing system 110 mounted inside the housing. The embedded computing system 110 is configured to be powered down and transported from one location to another. The embedded computing system 110 is further configured be powered up at the new location and connect automatically to the network 6.

The embedded computing system 110 may include an embedded personal computer constructed in general accordance with the computer 20 illustrated in FIG. 2 and described above. For illustrative purposes, like reference numerals have been used to identify like components of the embedded computing system 110 and the computer 20. However, the embedded computing system 110 differs from the computer 20 with respect to its user interface 114. Only components of the embedded computing system 110 that differ substantially from those of the computer 20 will be described in detail.

The embedded computing system 110 is coupled to additional user interface components not described with respect to the computer 20. Further, the embedded computing system 110 is restricted to having only user interface hardware components that cannot be used to introduce computer programs into the embedded computing system. The user interface 114 of the embedded computing system 110 includes a touch screen 114A. Optionally, the user interface 114 includes a credit card reader 114B, one or more speakers 114C, and/or a receipt printer 114D. The user interface 114 displays a kiosk shopping portal interface to a customer and receives order information from the customer. Optionally, the user interface 114 may also display a configuration interface for use by the user (owner or renter) of the kiosk.

The embedded computing system 110 includes a network connection 118, such as an Ethernet connection, WI-FI connection, cellular wireless broadband connection, any of the network connection components described with respect to computing device 20, and the like. By way of a non-limiting example, the kiosk 100 may be programmed with a telephone number to dial automatically immediately after being powered up. In this manner, the kiosk 100 may be connected to a cellular network. Once connected to the cellular network, the kiosk 100 may request Internet access. After being granted Internet Access, the kiosk 100 may establish a connection with the servers 8.

The kiosk 100 may also include an internal UPS 120 to handle power disruptions and fluctuations.

The other programming modules 37 stored in the system memory 22 of the kiosk 100 include a Kiosk Content Client Module 130, a Content Engine Mirror Module 132, and a Kiosk Management Client Module 134. The program data 38 stored in the system memory 22 of the kiosk 100 includes shopping data 138. The shopping data 138 includes information used to display advertisements to customers and product information used to present product offerings to customers.

The Kiosk Content Client Module 130 generates and displays the kiosk shopping portal interface on the user interface 114 (e.g., on the touch screen 114A) of the kiosk 100. The kiosk shopping portal interface provides the only access to the embedded computing system 110 available to customers.

The Content Engine Mirror Module 132 stores and manages the shopping data 138 stored in the program data 38. Because the shopping data is stored locally in the kiosk 100, the kiosk need only contact the servers 8 for credit card approval and order submission. New or modified shopping data 138 can be pushed from the servers 8 to the Content Engine Mirror Module 132 at any convenient time, such as during off hours.

The Kiosk Management Client Module 134 is responsible for monitoring the health of the kiosk 100, reporting the kiosk's status and recent history back to the servers 8, and for taking autonomous recovery actions when the kiosk experiences a system failure (e.g. the kiosk is disconnected from the Internet for too long, etc.). The Kiosk Management Client Module 134 also displays the configuration interface to the user. Using the configuration interface, the user may instruct the kiosk 100 to request shopping data 138 from the servers 8, specify the network address(es) of the servers 8, select which products the kiosk will offer for sale, and the like.

The kiosk shopping portal interface is a touch-focused interface presented on the user interface 114 (e.g., on the touch screen 114A) of the kiosk 100 that allows customers to interact with the embedded computing system 110, browse through available products, select products for purchase, purchase selected products with their credit card, and indicate an address to which to ship the purchase.

The kiosk 100 may be constructed to be portable. In such embodiments, the kiosk 100 may include wheels. Alternatively, the kiosk 100 may be transportable on a dolly. As mentioned above, the kiosk 100 may be leased or sold to users and placed in locations permanently or temporarily. For example, a user may transport the kiosk 100 to the location of an event, such as a sporting event, configure the kiosk for use, and remove the kiosk from the location of the event after the event is over. The shopping data 138 may be targeted to customers likely to be at the location of the kiosk 100. For example, if the kiosk 100 is located at an automotive parts store, the shopping data 138 may include products related to automobiles. Similarly, if the kiosk 100 is located at a sporting event, the shopping data 138 may include products related to that event, such as hats, pennants, shirts, and the like bearing the names of the participants in the event.

The user or a kiosk technician may perform hardware and software maintenance on the kiosk 100. Hardware updates may include anything from repairing damage to the kiosks, replacing low receipt paper rolls, or replacing old or faulty UPS units. Software maintenance includes initial field configuration and major upgrades. As part of a kiosk installation, information in the kiosk may be updated, such as location of the kiosk, setup parameters related to the network connection 118, and the like.

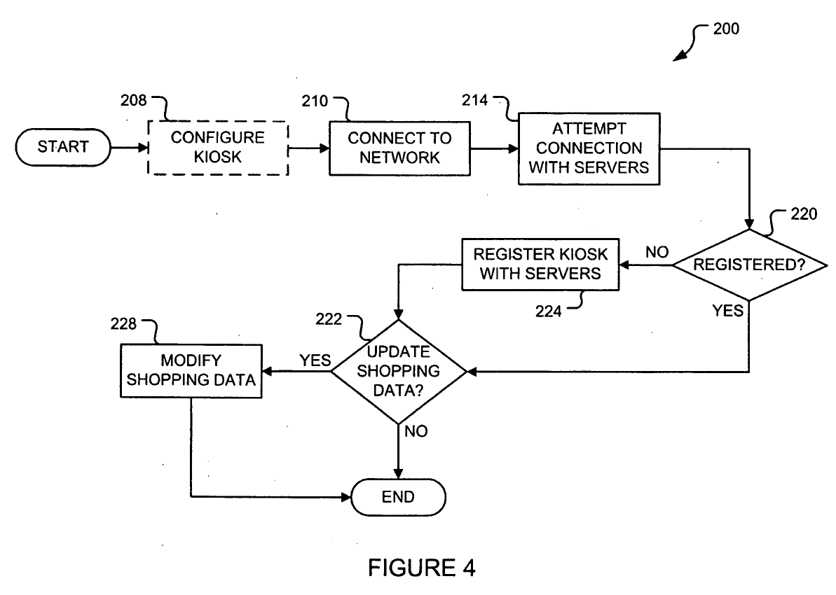

FIG. 4 is a flow diagram of a method 200 that may be performed by the system 2 after the kiosk 100 is positioned in a location, coupled to a power source (not shown), and powered up. Specifically, the method 200 may be performed by the Kiosk Management Client Module 134 using its configuration interface, the Content Engine Mirror Module 132, and the servers 8.

In first optional block 208, the kiosk 100 may be configured by a user. By way of a non-limiting example, the user may configure the kiosk 100 to connect to the network 6, the servers 8, or both. To configure the kiosk 100, the configuration interface displayed by the Kiosk Management Client Module 134 may require user authentication (i.e., user identification and a password). The user may provide a network address (e.g., Uniform Resource Locator (“URL”)) with which the kiosk 100 may contact the servers 8 over the network 6.

In next block 210, the Kiosk Management Client Module 134 establishes a connection to the network 6 using its network connection 118.

In block 214, the kiosk 100 attempts to connect to the servers 8. By way of a non-limiting example, the Kiosk Management Client Module 134 may dial into a cellular network, establish a broadband connection with the Internet, and use a URL stored in system memory 22 to access the servers 8 over the Internet.

Next, in decision block 220, the servers 8 determine whether the kiosk 100 is registered with the servers 8. If the kiosk 100 is registered, the decision in block 220 is “YES,” and the method 200 advances to decision block 222. If kiosk 100 is not registered with the servers 8, the decision in block 220 is “NO,” and the method 200 advances to block 224.

As discussed above, in its system memory 22, the kiosk 100 stores shopping data 138 to be displayed on its user interface 114. In decision block 222, at least one of the kiosk 100 and the servers 8 decide whether to update the shopping data 138 stored in the memory 22 of the kiosk 100. If the decision in decision block 222 is “YES,” in block 228, the servers 8 push shopping data 138 to the Content Engine Mirror Module 132 of the kiosk 100 over the network 6 via the network connection 118. Optionally, if the kiosk 100 made the decision in block 222, the kiosk may have sent a request to the servers 8 to push shopping data 138 to the kiosk 100. Otherwise, if the decision in decision block 222 is “NO,” the method 200 terminates.

In block 224, the configuration interface of the Kiosk Management Client Module 134 is used to register the kiosk 100 with the servers 8. This process may include a login procedure. Then, the method 200 advances to decision block 222.

After block 228, the kiosk 100 is ready to display an advertising screen on its user interface 114 (e.g., touch screen 114A) and wait for a customer. Because the kiosk 100 is configured and ready for use by a customer, the method 200 terminates.

Periodically, at random times, or at predetermined times, the Content Engine Mirror Module 132 of the kiosk 100 may query the servers 8 for updated shopping data. In particular embodiments, the kiosk 100 may transmit a request to the servers 8 requesting updated shopping data 138 at predetermined times during the day. In response to the request, the servers 8 push updated shopping data to the kiosk 100 if any is available.

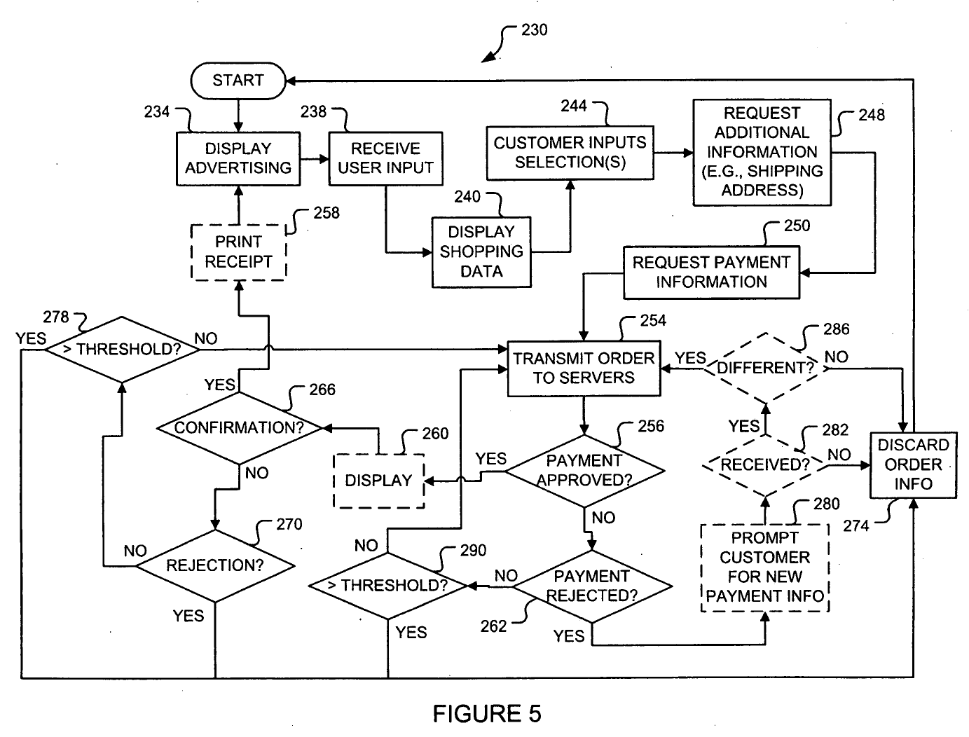

FIG. 5 is a flow diagram of a method 230 that may be performed by the system 2 after the kiosk 100 is ready for use by a customer. Specifically, the method 230 may be performed by the Kiosk Content Client Module 130 and its the kiosk shopping portal interface displayed on the user interface 114 (e.g., on the touch screen 114A) and the servers 8.

In first block 234, the Kiosk Content Client Module 130 displays a welcome screen, an advertising screen, and the like on its user interface 114 (e.g., touch screen 114A) and waits for a customer. The advertising screen presents one or more options to the customer.

In block 238, the kiosk 100 receives input from a customer. In response to this input, in block 240, the kiosk 100 displays at least a portion of the shopping data 138 (e.g., product information, prices, etc.) and/or options to the customer using the kiosk shopping portal interface. The shopping data 138 and/or options may be displayed on one or more pages or screens. The customer may browse products by navigating between these pages using any method known in the art. By way of a non-limiting example, the pages may be designed to resemble web pages and the user may navigate the product information and/or options using familiar Internet browser user interface options, such as “Next,” “Back,” “Submit,” and the like.

Once the customer has decided to purchase a product, in block 244, the kiosk shopping portal interface receives customer inputs related to one or more purchase selections. As mentioned above, the customer may enter product selections that are collected in a shopping cart type interface. When the customer has decided to complete the transaction, the customer may indicated he/she would like to check out. Then, in block 248, the kiosk 100 prompts the customer for customer information such as name, an email address, the delivery address, and the like. To obtain this information, the kiosk shopping portal interface may display an image of a keyboard on the touch screen 114A that the customer may use to enter the information requested.

Then, in block 250, the kiosk shopping portal interface asks the customer for payment information. By way of a non-limiting example, in block 250, the kiosk 100 asks the customer to input his/her credit card information using the credit card reader 114B.

After the customer has entered all of the necessary information, in block 254, the kiosk 100 transmits the order information to at least one of the servers 8 for processing. When the order information is sent, the kiosk 100 may also send diagnostic information to the servers 8 indicating the status of the kiosk 100.

In decision block 256, the kiosk 100 determines whether it has received a payment approval notification from the servers 8. If the decision in decision block 256 is “YES,” the payment has been approved by the payment processor 10 and the kiosk 100 advances to block 260. If the decision in decision block 256 is “NO,” the notification may not have been sent or the payment may have been rejected by the payment processor 10 and the kiosk 100 advances to decision block 262.

In block 260, the kiosk 100 may display a notification to the customer indicating the order has been approved by the payment processor 10. In some embodiments, following this notification, the method 230 may advance directly to optional block 258. Alternatively, the method 230 may advance to decision block 266.

In decision block 266, the kiosk 100 determines whether it has received a confirmation message from the servers 8 confirming the order. If the decision in decision block 266 is “YES,” the confirmation message has been received and the kiosk 100 advances to optional block 258.

In optional block 258, the kiosk 100 prints a receipt for the customer using the receipt printer 114D and the method 230 returns to block 234. Optionally, the kiosk 100 may email a receipt to the customer using the email address input by the customer. Optionally, the kiosk 100 may inform the customer that the order has been confirmed by displaying this information on the touch screen 114A and/or sending the customer an email using the email address entered by the customer. The kiosk 100 may also display a thank you message to the customer. Further, if a promotion is available (e.g., a coupon for additional purchases), the kiosk 100 may display information related to the promotion.

If the decision in decision block 266 is “NO,” the confirmation message has not been received and the kiosk 100 advances to decision block 270. In decision block 270, the kiosk 100 determines whether it has received an order rejection message from the servers 8. If the decision in decision block 270 is “YES,” an order rejection message has been received and the kiosk 100 advances to block 274. In block 274, the kiosk 100 discards the order information and the method 230 returns to start. Optionally, the kiosk 100 may inform the customer that the order cannot be processed or has been rejected. Alternatively, the method 230 may return to block 240 and allow the customer to modify the order for resubmission to the servers 8. For example, if the order was rejected because a product ordered is no longer available or not available in the quantity ordered, the customer may revise the order to avoid this limitation.

If the decision in decision block 270 is “NO,” an order rejection message has not been received and the kiosk 100 advances to decision block 278. At decision block 278, the kiosk 100 determines whether it has sent the order information to the servers 8 more than a threshold number of times (e.g., more than two times, three times, four times, etc.). If the decision in decision block 278 is “YES,” the kiosk 100 advances to block 274.

If the decision in decision block 278 is “NO,” the kiosk 100 has not sent the order information to the servers 8 more than the threshold number of times, and the kiosk 100 returns to block 254 to resend the order information to the servers 8.

In decision block 262, the kiosk 100 determines whether it has received a payment rejection message from the servers 8. At this point, the kiosk 100 informs the customer that the payment information has been rejected. In optional block 280, the kiosk 100 prompts the customer for different payment information.

In optional decision block 282, the kiosk 100 determines whether the customer provided new payment information. If the customer provided payment information, the kiosk 100 advances to decision block 286. If the customer did not provide payment information, the kiosk 100 advances to block 274.

In optional decision block 286, the kiosk 100 determines whether the customer provided different payment information from that provided previously. If the customer provided different payment information, the decision in decision block 286 is “YES,” and in block 254, the kiosk 100 transmits this different payment information to the servers 8. If the customer did not provide different payment information, the decision in decision block 286 is “NO,” and the kiosk 100 advances to block 274.

If the decision in decision block 262 is “NO,” a payment rejection message has not been received and the kiosk 100 advances to decision block 290. At decision block 290, the kiosk 100 determines whether it has sent the payment information to the servers 8 more than a threshold number of times (e.g., more than two times, three times, four times, etc.). If the decision in decision block 290 is “YES,” the kiosk 100 advances to block 274. If the decision in decision block 278 is “NO,” the kiosk 100 has not sent the order information to the servers 8 more than the threshold number of times, and the kiosk 100 returns to block 254 to resend the order information to the servers 8.

The method 230 continues until the kiosk 100 is powered down (e.g., disconnected from the power source) or disconnected from the network 6.

### Servers

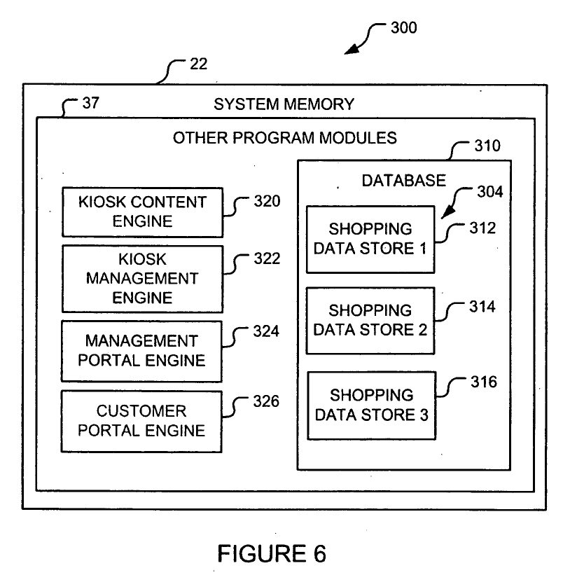

Servers configured to communicate over the network 6 and provide services over a network are well known in the art and will not be described in detail. FIG. 6 provides an illustration of the system memory 22 of an exemplary server 300. Each of the servers 8 illustrated in FIG. 1 may be constructed in accordance with the server 300. The server 300 may be implemented in the computing device 20 depicted in FIG. 2.

Product information 304 (e.g., shopping data) is stored in the system memory 22 of the server 300. By way of a non-limiting example, the product information may be stored in a database 310, or in the program data 38 (see FIG. 2). The database 310 may be used to store and maintain information related to products, stores (or product groupings), customers, vendors, orders, users, kiosks, fulfillment house 12, payment processor 10, account 11, and the like. In the embodiment depicted, the product information is organized into three product stores 312, 314, and 316.

The server 300 includes software modules stored in the other program modules 37 of the system memory 22. The software modules include a Kiosk Content Engine 320, a Kiosk Management Engine 322, a Management Portal Engine 324, and a Customer Portal Engine 326.

The Kiosk Content Engine 320 generates the content presented to the customer on the user interface 114 (see FIG. 3) of the kiosk 100. The Kiosk Content Engine 320 combines the display logic, graphical infrastructure, and product information 304 stored in the database 310 to produce the content that pushed to the kiosk 100 for display thereby.

The Kiosk Management Engine 322 is responsible for monitoring the health of the kiosks 4 in the system 2 and issuing alerts and alarms if there are issues with one or more of the kiosks. The Kiosk Management Engine 322 processes kiosk information such as, but not limited to, a kiosk health maintenance status indicator, a kiosk operational healthy status indicator, and a kiosk maintenance status indicator. Optionally, kiosk information is stored in the database 310.

The kiosk health maintenance status indicator indicates whether the kiosk 100 is alive (i.e., functional), rebooting, under maintenance, or dead (i.e., non-functional). The kiosk 100 is considered to be alive if it is responsive. The kiosk 100 reports health related information to the Kiosk Management Engine 322. For example, the kiosk 100 reports a reboot state to the Kiosk Management Engine 322 when the kiosk is about to perform a reboot operation. The Kiosk Management Engine 322 then changes the kiosk health maintenance status indicator to indicate the kiosk is rebooting. Following the reboot operation, the kiosk 100 reports an operational state to the Kiosk Management Engine 322. The Kiosk Management Engine 322 then changes the kiosk health maintenance status indicator to indicate the kiosk is alive.

Similarly, when the kiosk is about to be taken down for maintenance, the kiosk 100 reports an under maintenance state to the Kiosk Management Engine 322. The Kiosk Management Engine 322 then changes the kiosk health maintenance status indicator to indicate the kiosk is under maintenance. Following the completion of the maintenance, the kiosk 100 reports the operational state to the Kiosk Management Engine 322. The Kiosk Management Engine 322 then changes the kiosk health maintenance status indicator to indicate the kiosk is alive.

If the kiosk health maintenance status indicator indicates the kiosk 100 has remained in the reboot state or the under maintenance state for too long (e.g., about 10 minutes, about 20 minutes, etc.) or if the kiosk stops responding, the kiosk health maintenance status indicator may be modified to indicate the kiosk is dead.

The kiosk operational healthy status indicator indicates whether the kiosk 100 is healthy, has questionable health, or is in a health crisis state. The kiosk 100 is considered healthy if the processing unit 21 (see FIG. 3) is not under an unreasonable load, there is free memory, and the network connection 118 (see FIG. 3) has adequate bandwidth (offering adequate communication speed) and is stable. The kiosk 100 is considered to be in a health crisis state if any of these factors are degraded to the point that the kiosk's operations are clearly negatively impacted. In other words, performance criteria may be established for each of the aforementioned factors. Performance above a first set of criteria indicates the kiosk 100 is healthy. Performance below a second set of criteria indicates the kiosk 100 is in the health crisis state. The kiosk 100 is considered to be in questionable health if its performance with respect to any of the factors is between the healthy and health crisis state.

The kiosk maintenance status indicator indicates whether the kiosk 100 is in good maintenance, needs maintenance soon, or is in need of immediate maintenance. The kiosk 100 is considered to be in good maintenance if the printer paper level is satisfactory and the credit card reader 114B (see FIG. 3) reads a customer's credit card a majority of the time. The kiosk 100 is considered to require maintenance soon if the printer paper level is low or the credit card reader 114B fails to read a customer's credit card more than a first predetermined portion of the time. The kiosk 100 is considered to need immediate maintenance if the printer paper is empty or the credit card reader 114B fails to read a customer's credit card more than a second predetermined portion of the time. The second predetermine portion of the time may be a major of the time.

The Management Portal Engine 324 is responsible for providing content to the management portal 17B. By way of a non-limiting example, the content may be presented as web pages viewable by the client computing device 16B using a web browser, such as Internet Explorer, Firefox, and the like.

The Customer Portal Engine 326 is responsible for providing content to the customer portal 17A. By way of a non-limiting example, the content may be presented as web pages viewable by the client computing device 16A using a web browser, such as Internet Explorer, Firefox, and the like.

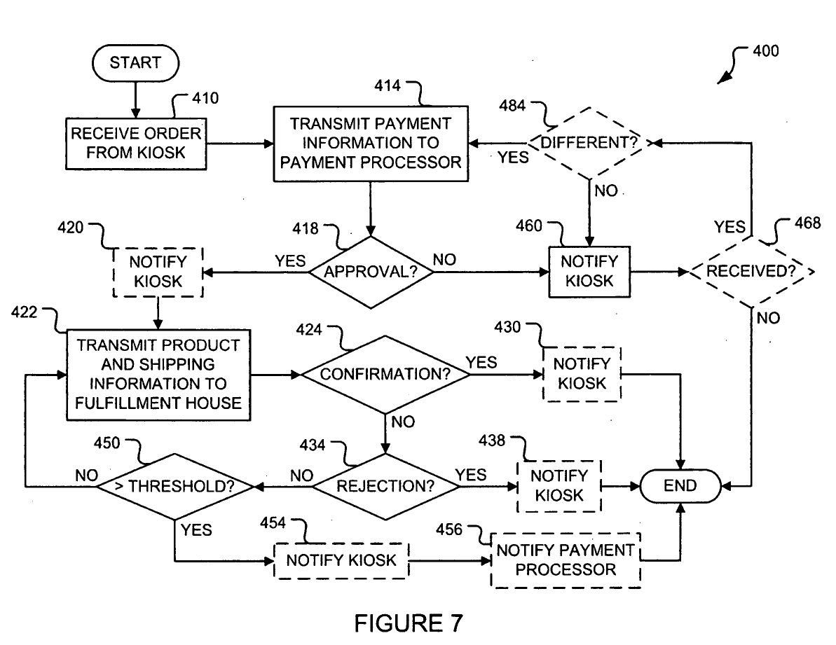

The servers 8 separately and/or together perform a method 400 depicted in FIG. 7. Referring also to FIG. 1, for ease of illustration, the method 400 will be described as being performed by only the server 8A.

In first block 410, the server 8A receives order information from one of the kiosks 4. For ease of illustration, it will be assumed the server 8A received order information from the kiosk 4A.

In block 414, the server 8A sends the payment information portion of the order information to the payment processor 10 and waits for an indication from the payment processor that the payment is approved.

In decision block 418, the server 8A determines whether it has received an approval indication from the payment processor 10. If the decision in decision block 418 is “YES,” the payment has been approved by the payment processor 10 and the server 8A advances to optional block 420. In optional block 420, the server 8A sends a notification to the kiosk 4A that the payment information has been approved. In response to receiving this notification, optionally, the kiosk 4A may inform the customer that the payment information has been approved. Then, the server 8A advances to block 422.

In some embodiments, after receiving notification that the payment has been approved, the servers 8 may store the order and wait to transmit it to the fulfillment house 12. In such embodiments, the method 400 may wait a predetermined amount of time or until a previously scheduled time before advancing to block 422.

In block 422, the server 8A sends the product and shipping information to the fulfillment house 12 and waits for a confirmation message from the fulfillment house.

In decision block 424, the server 8A determines whether it has received a confirmation message from the fulfillment house 12. If the decision in decision block 424 is “YES,” the confirmation message has been received and the server 8A advances to optional block 430. In optional block 430, the server 8A sends a notification to the kiosk 4A informing the kiosk that the order has been confirmed and the method 400 terminates. Optionally, the kiosk 4A may inform the customer that the order has been confirmed.

If the decision in decision block 424 is “NO,” the confirmation message has not been received and the server 8A advances to decision block 434. In decision block 434, the server 8A determines whether it has received an order rejection message from the fulfillment house 12.

If the decision in decision block 434 is “YES,” an order rejection message has been received and the server 8A advances to optional block 438. In optional block 438, the server 8A sends a notification to the kiosk 4A informing the kiosk that the order has been rejected and the method 400 terminates. Optionally, the kiosk 4A may inform the customer that the order has been rejected. Optionally, the server 8A may send an email to the customer notifying the customer that the order could not be processed.

If the decision in decision block 434 is “NO,” an order rejection message has not been received and the server 8A advances to decision block 450. At decision block 450, the server 8A determines whether it has sent the order and shipping information to the fulfillment house 12 more than a threshold number of times (e.g., three times, four times, five times, etc.). If the decision in decision block 418 is “YES,” the server 8A advances to optional block 454, whereat the server 8A sends a notification to the kiosk 4A informing the kiosk that the order cannot be processed. Optionally, the kiosk 4A may inform the customer that the order cannot be processed. Optionally, the server 8A may send an email to the customer notifying the customer that the order could not be processed.

If the customer's account was debited by the payment processor 10, in optional next block 456, the server 8A may instruct the payment processor 10 to refund the amount debited to the customer's account. Then, the method 400 terminates.

If the decision in decision block 450 is “NO,” the server 8A has not sent the order and shipping information to the fulfillment house 12 more than the threshold number of times, and the server 8A returns to block 422 to resend the information to the fulfillment house 12.

If the decision in decision block 418 is “NO,” the payment has not been approved by the payment processor 10 and the server 8A advances to block 460. In block 460, the server 8A sends a notification to the kiosk 4A that the payment information has been rejected and the order cannot be processed. At this point, the kiosk 4A informs the customer that the payment information has been rejected. As discussed above with respect to method 230 (see FIG. 5), the kiosk 4A may prompt the customer for different payment information.

Optional decision block 468 determines whether the server 8A received new payment information from the kiosk 4A. If the kiosk 4A sent payment information, the decision in decision block 468 is “YES,” and the server 8A advances to decision block 484. If the customer did not provide new payment information, the decision in decision block 468 is “NO,” and the method 400 terminates.

In decision block 484, the server 8A determines whether it has received different payment information from that received previously. If the decision in decision block 484 is “YES,” the server 8A has received different payment information from the kiosk 4A and the server 8A returns to block 414. If the decision in decision block 484 is “NO,” the server 8A has not received different payment information from the kiosk 4A, and in block 460, the server notifies the kiosk that the payment information has been rejected and the order cannot be processed. Before terminating, the method 400 may send an instruction to the kiosk 4A instructing it to display a message to the customer indicating the transaction has ended and the reason why it has ended (e.g., order confirmed, payment information declined, and order could not be processed).

### Customer Portal

The customer portal 17A provides the customer's post-purchase interface for tracking and canceling their orders. After completing an order transaction, the customer receives a receipt and/or a confirmation email (if an email address was provided). The receipt and/or email may provide a network address (e.g., URL) and login information (e.g., a login identification and/or password) that the customer may use to log into the customer portal 17A. Using the customer portal 17A, the customer can view their current and past transactions, cancel pending transactions, and update customer information. Further, if the fulfillment house 12 encounters a problem with the order, the fulfillment house may notify the servers 8 regarding the problem. The servers 8 may email the customer information related to the problem. The customer may subsequently log onto the customer portal 17A and address the problem.

### Management Portal

The management portal 17B may be configured to provide different levels of access to different users. For example, the management portal 17B may provide administrator level access. A user with administrator level access has complete access to and control over the management portal 17B. A user with administrator level access may view, modify, add, and remove information stored in the database 310. For example, a user with administrator level access can add a new kiosk to the database 310 and associate one or more of the stores 312, 314 and 316 with the kiosk. A user with administrator level access can also modify which of the stores 312, 314 and 316 is associated with each of the kiosks 4. Depending upon implementation details, a user with administrator level access may do any of the following: modify global settings; create, modify, and delete product stores; and manage user login and access privileges. Further, a user with administrator level access may control access to the payment processor, (e.g., control an Authorize.Net credit card authentication key).

By way of another non-limiting example, the management portal 17B may provide product coordinator level access. A user with product coordinator level access has limited access and visibility within the management portal. Such as user may add, modify, and remove product categories. A user with product coordinator level access may also add, modify, and remove products (and information related thereto) within one or more stores.

By way of another non-limiting example, the management portal 17B may provide kiosk technician level access. A user with kiosk technician level access may view kiosk health and maintenance information. A user with kiosk technician level access has limited access and visibility within the management portal 17B to track and view the health, maintenance, and operational status of the kiosks under their purview. For example, if the diagnostic information is not sent by the kiosk 4A to the servers 8 for more than a predetermined amount of time, the management portal 17B may indicate a problem with respect to the kiosk 4A. Further, the management portal 17B may indicate a kiosk is out of printer paper, disconnected from the servers 8, malfunctioning, and the like.

By way of another non-limiting example, the management portal 17B may provide shipping and handling clerk level access. A user with shipping and handling clerk level access may monitor orders to ensure customers receive products that they ordered. A user with shipping and handling clerk level access has limited access and visibility within the management portal 17B to track, update, and manage customer purchases within one or more stores.

By way of another non-limiting example, the management portal 17B may provide kiosk host level access. A person (or an agent of an entity) with this level of access typically provides floor space to and hosts the kiosk 100. A user with kiosk host level access is limited to viewing reports. Such reports may include reports related to kiosk traffic, order information (with customer personal information redacted therefrom), kiosk health information, and the like. A user with this level of access does not have the ability to control, modify, or otherwise manage the content displayed by the kiosks 4 via the management portal 17B. Such as user also lacks the ability to control, modify, or otherwise manage the kiosks 4 via the management portal 17B.

A user with administrator level access may have access to the functionality provided to users with other levels of access (e.g. product coordinator level access, kiosk technician level access, shipping and handling clerk level access, and kiosk host level access).

The system 2 allows users (purchasers, renters, and the like) of kiosks to provide customers virtual access to a wide variety of products while consuming a limited amount of floor space and without having to maintain an inventory of the those products. The system 2 allows customers to shop among a large selection of products and have those products shipped to any destination specified. The customer portal 17A of the system 2 allows customers to track present and past orders. The management portal 17B allows users and system operators to management kiosks, products and content presented on the kiosks, the order and shipment process, and the system as a whole.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for use with a payment processor and a fulfillment house both coupled to a network, the payment processor being configured to receive payment information, determine whether a customer account has sufficient funds, if the customer account has sufficient funds, transfer funds from the customer account to a system operator account, and transmit a payment approve message, and if the customer account lacks sufficient funds, the payment processor being further configured to transmit a payment rejection message, the fulfillment house being configured to receive an order identifying at least one product and comprising a shipping address and in response to receiving the order, ship the at least one product identified by the order to the shipping address, the system comprising:
a plurality of kiosks each comprising an embedded computing system having a system memory comprising information related to a plurality of product offerings and a user interface configured to display information related to at least a portion of the plurality of product offerings to a customer without accessing the network, receive an order and related payment information from the customer, and in response to receiving the order, transmit the order and related payment information over the network; and
at least one server coupled to the plurality of kiosks over the network, the at least one server being configured to receive orders and related payment information transmitted by the kiosks and in response to receiving the payment information, transmit the payment information to the payment processor, the at least one server being further configured to receive payment accept or rejection messages from the payment processor, and for orders for which accept messages were received, transmit the orders over the network to the fulfillment house.

2. The system of claim 1, wherein the at least one server comprises a plurality of stores, each store comprising information related to a different plurality of product offerings, the at least one server being configured to associate each of the plurality of kiosks with at least one of the plurality of stores and update the information related to a plurality of product offerings stored in the system memory of each kiosk using the information related to the different plurality of product offerings of the store associated with the kiosk.

3. The system of claim 1, wherein the at least one server is configured update the information related to the plurality of product offerings stored in the system memory of each kiosk at one or more predetermined times.

4. The system of claim 1, wherein each of the plurality of kiosks is portable and configured to be movable from a first location to a second location, when located in the first location, the system memory of the kiosk comprising first information related to a first plurality of product offerings and when located in the second location, the system memory of the kiosk comprising second information related to a second plurality of product offerings, the second plurality of product offerings being different from the first plurality of product offerings.

5. The system of claim 4, wherein after the kiosk is located in the first location, the kiosk downloads the first information related to the first plurality of product offerings from the at least one server, and after the kiosk is located in the second location, the kiosk downloads the second information related to the second plurality of product offerings from the at least one server.

6. The system of claim 1, wherein each of the plurality of kiosks is configured to transmit diagnostic information to the at least one server, and
the at least one server is configured to receive diagnostic information from each of the plurality of kiosks.

7. The system of claim 6, further comprising a management portal configured to display the diagnostic information received by the at least one server.

8. The system of claim 1 for use with a fulfillment house further configured to in response to receiving the order, determine whether the order can be filled, if the order can be filled, transmit an order confirmation message to the at least one server, and if the order cannot be filled, transmit an order rejection message to the at least one server, the at least one server being configured to receive order confirmation and rejection messages transmitted by the fulfillment house and in response to receiving an order rejection message, notify the kiosk that transmitted the order that the order cannot be processed.

9. The system of claim 8, wherein in response to receiving an order confirmation message, the at least one server is further configured to notify the kiosk that transmitted the order that the order will be processed.

10. The system of claim 1, wherein for orders for which accept messages were received, the at least one server is configured to periodically transmit the orders over the network to the fulfillment house.

11. The system of claim 1, wherein after being powered up, the embedded computing system of each of the plurality of kiosks is configured to automatically connect to the at least one server over the network.

12. The system of claim 1, wherein the plurality of kiosks are each configured to request updated information related to the plurality of product offerings from the at least one server.

13. The system of claim 1, wherein the at least one server is configured to transmit updated information related to the plurality of product offerings to selected ones of the plurality of kiosks.

14. The system of claim 1, wherein the user interface of each of the plurality of kiosks is configured to receive an email address from the customer, and transmit the email address to the at least one server, and
the at least one server is further configured to receive the email address and transmit order related information to the email address.

15. The system of claim 1, wherein the at least one server comprises a customer portal configured to display order related information to the customer and allow the customer to modify the order.

16. The system of claim 15, wherein the customer portal comprises a network address;
the user interface of each of the plurality of kiosks is configured to receive an email address from the customer, and transmit the email address to the at least one server, and
the at least one server is further configured to receive the email address and transmit the network address of the customer portal and login information to the email address.

17. The system of claim 1, wherein the embedded computing system of each of the plurality of kiosks is coupled to the network by a wireless connection.

18. The system of claim 1 wherein the user interface of each of the plurality of kiosks comprises a printer configured to print a receipt for the customer.

19. The system of claim 1, wherein the user interface of each of the plurality of kiosks comprises a credit card reader configured to receive the payment information related to the order received from the customer.

20. The system of claim 1, wherein the user interface of each of the plurality of kiosks comprises a touch screen configured to display product offerings to customers and receive orders from the customers.

21. The system of claim 1, wherein in response to receiving payment accept messages, the at least one server is further configured to transmit the payment accept messages to the plurality of kiosks,
in response to receiving payment rejection messages, the at least one server is further configured to transmit the payment rejection messages to the plurality of kiosks, and
the plurality of kiosks are each configured to display to a customer an indication of whether payment information related to an order was rejected or accepted based on the receipt of a payment rejection message or payment approve message.

22. A method comprising:
transporting a kiosk to a first location whereat a first event is occurring;
configuring the kiosk to offer only a predetermined plurality of products associated with the first event for sale, the kiosk being configured to accept orders comprising a shipping address for selected ones of the predetermined plurality of products from customers and transmit the orders accepted to at least one remote server for shipment to the shipping address of the order; and
at a location remote from the first location, monitoring the kiosk.

23. The method of claim 22, wherein monitoring the kiosk comprises collecting information related to orders accepted by the kiosk.

24. The method of claim 22, wherein the kiosk comprises a printer configured to print receipts on paper, and monitoring the kiosk comprises determining when the printer is out of paper.

25. The method of claim 22, further comprising:
configuring the kiosk to communicate with the at least one remote server over a network.

26. The method of claim 22, further comprising:
transporting the kiosk to a second location whereat a second event is occurring, the second event being different from the first event;
configuring the kiosk to offer only a predetermined plurality of products associated with the second event for sale, the kiosk being configured to accept orders comprising a shipping address for selected ones of the predetermined plurality of products associated with the second event from customers and transmit the orders accepted to at least one remote server for shipment to the shipping address of the order.

27. The method of claim 26, further comprising at a location remote from the second location, monitoring the kiosk.

28. A method comprising:
for each of a plurality of product groupings, creating an advertising display, each of a plurality of product groupings comprising a plurality of products;
for each of the plurality of product groupings, configuring at least one kiosk to offer only the plurality of products of the product grouping for sale and to display the advertising display of the product grouping, the at least one kiosk configured for each of the plurality of product groupings defining a plurality of kiosks; and
for each of plurality of kiosks, receiving orders from the kiosk and transmitting those orders to a remote fulfillment house for processing.

29. The method of claim 28, further comprising: leasing each of plurality of kiosks to a user.

30. The method of claim 28, further comprising: transmitting a payment information portion of the orders received to a payment processor.

31. The method of claim 28, further comprising: selecting the plurality of product groupings.

32. The method of claim 31, further comprising: selecting the plurality of products in each of the plurality of product groupings.

33. The method of claim 28, further comprising: placing each of the plurality of kiosks in a location related to the plurality of products offered for sale by the kiosk.

34. The method of claim 28, further comprising: tracking orders received from the plurality of kiosks to determine sales information and displaying the sales information to a user.
